(19) United States
(12) Patent Application Publication
(10) Pub. No.: US 2025/0278401 A1
(43) Pub. Date: Sep. 4, 2025

(54) DASHBOARD METADATA AS TRAINING DATA FOR NATURAL LANGUAGE QUERYING

(71) Applicant: Selector Software, Inc., Santa Clara, CA (US)

(72) Inventors: Surya Chandra Sekhar Nimmagadda, Santa Clara, CA (US); Sebastian Reyes, Santa Clara, CA (US); Aiden Watson, Santa Clara, CA (US)

(21) Appl. No.: 18/593,872

(22) Filed: Mar. 2, 2024

(51) Int. Cl. G06F 16/2452; G06F 40/295

(52) U.S. Cl. CPC G06F 16/24522; G06F 40/295

(57) ABSTRACT

Systems, apparatuses, and methods for generating training data for machine learning models are disclosed. In an implementation training data for machine learning models can be created without requiring manual labeling and annotation of data. Natural language data from dashboards and widgets is extracted to identify user context. The user context is used to generate alias data strings that each correlate user context with natural language text. These alias data strings are used to train the machine learning model. Using user context derived from natural language text as basis to train the models, allows the system to generate accurate training data, without needing an end-user or system administrator to create a labeled set of data.

### BACKGROUND

### Description of the Related Art

Currently, for operations management of network-based services, users create multiple dashboards for each operational monitoring tool. These dashboards present metrics associated with functionalities of a given network-based service or device, as generated by a given operational monitoring tool. In case of issues such as outages, users can generate relevant dashboards in the dashboard lists and/or directories and look at key performance metrics to determine the root-cause of the issue.

In some network-management systems, free-form or natural language text originating from end-user devices can be analyzed, e.g., using large language models (LLMs), to identify which dashboards are requested by any given user. In such systems, each time a different user (or entity) inputs natural language queries into the system, the training data for the LLMs needs to be relabeled, such that the LLM can adequately identify underlying database queries for creating dashboards or widgets. Therefore, the conventional methods of generating training data for natural language querying are inefficient, owing to repeated relabeling of training data, each time new free-form or natural language phrases are encountered. Further, as each customer may have their own specific terminology, each model needs to be trained on every customer's domain-specific networking data. This results in increased time, efforts, as well as computing resource usage for the network management system.

In view of the above, improved systems and methods for generating training data for natural language querying are needed.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of an exemplary network implementation of an operations monitoring system.

FIG. 2 is a block diagram of exemplary implementation of various units of the operations monitoring system.

FIG. 3 is a block diagram illustrating creation of alias dataset using dashboard metadata.

FIG. 4 is a block diagram illustrating creation of additional aliases by extrapolating previously created aliases.

FIG. 5 is a illustrates a method for using dashboard metadata as training data for training a machine learning model.

FIG. 6. Illustrates a method for updating alias data by extrapolating existing natural language text.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for using dashboard metadata as training data for training machine learning models are described. In one implementation, alias dataset is created, including individual aliases or alias data strings, wherein each alias is a textual identifier mapping a natural language query with its intended context. Each time a user device enters a natural language query to access data from a network management system (e.g., Artificial Intelligence Operations or AIOps system), the natural language query is analyzed to generate the requested data. In one implementation, this analysis is based on identifying the alias corresponding to the natural language query and generate one or more database queries using the alias. These database queries are then resolved by the system to output data requested by the user device. In an example, the aliases created by the system can be used to train machine learning models (e.g., large language models or “LLMs”), such that the LLMs can process natural language queries obtained from user devices and generate data requested by these queries.

In an implementation, using aliases as training data for LLMs can be beneficial in making the models understand and identify various natural language combinations of text that can be used by different users. For instance, each user (or organizational entity) may use different keywords or search terms to solicit data from the AIOps system, and therefore, the alias dataset needs to be modified by manual labeling for different end-users. This becomes more crucial since each natural language query needs to be annotated with its corresponding alias data string. This annotation process may require domain knowledge to ensure that the trained models can predict, within a desired range of accuracy, underlying data requested by the users, by processing their queries received in natural language format.

In an implementation, using techniques described in this disclosure, accurate training data for machine learning models can be generated, without requiring manual labeling and annotation of data. This is done, in one implementation, by extracting natural language data entered by the user while interacting with the network management system(s) and using this data to augment the alias dataset. This allows the system to automatically update or recreate the alias dataset, without needing an end-user or system administrator to annotate data based on different user contexts. Further, as data is populated using end-users' specific domain language, the data thus generated is accurate and efficient. Further, for known entities, the augmented alias data can further be utilized to identify new templates for natural language queries, even before the queries are encountered by the system. The new templates can be extrapolated to create additional alias data. These and other implementations are described in the text that follows.

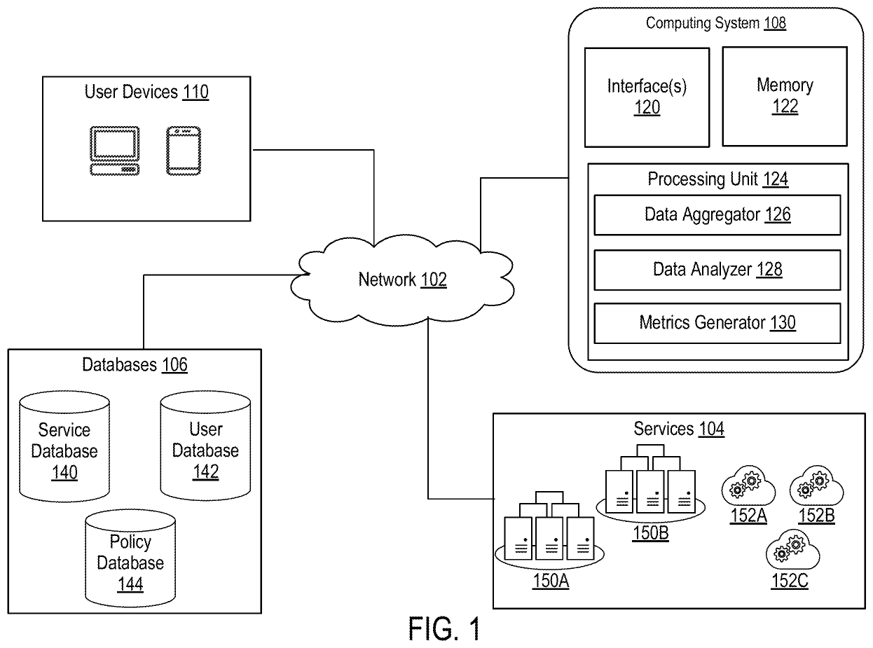

Turning now to FIG. 1, a network implementation 100 for functioning of a computing system 108 (alternatively referred to as operations management system or OMS 108) is illustrated. In an implementation, the operations management system 108 is configured to manage operations and maintenance of one or more services 104, over a network 102. In one implementation, services 104 managed by the operations management system 108 can include one or more physical infrastructures, e.g., datacenter 150A and datacenter 150B (collectively referred to as datacenters 150). Further, the services 104 can also include software services, e.g., cloud-based services 152A, 152B, and 152C (collectively referred to as cloud services 152). In an example, datacenters 150 may include on-site datacenters such as Information Technology (IT) equipment, such as computers, networks, and storage systems, and are located and used to support the operation of a particular business. The equipment in the datacenters 150 can be used to run important applications, services, and store critical data for businesses. Similarly, cloud services 152 include services that may allow businesses to access and use IT resources, such as applications, development platforms, servers, storage, and virtual desktops, over the internet or a dedicated network. Other examples of services 104 are contemplated.

The OMS 108 is configured to analyze operational metrics of the services 104 and provide this data to one or more user devices 110 over the network 102. In one example, the user devices 110 include devices used by IT administrators, network engineers, and/or maintenance personnel to inspect performance of the services 104, either on-site or remotely. User devices 110 can include personal computers, digital assistants, smartphones, tablets, and laptops, can be connected to the network 102 or operate independently. These devices may also have various external or internal components, like a mouse, keyboard, or display. User devices 110 can run a variety of applications, such as word processing, email, and internet browsing, and can be compatible with different operating systems like Windows or Linux.

The OMS 108 is further connected to one or more databases 106, over the network 102, such that data generated as a result of execution of instructions by the operations management system 108, is stored in at least one of the databases 106. In one implementation, the databases 106 can be internal to the operations management system 108. The databases 106 at least comprise a service database 140, a user database 142, and a policy database 144. The service database 140, in an implementation, can be used to store data associated with one or more of the services 104. The data can include business data, location data, equipment data, maintenance data, and the like for one or more services 104. The user database 142, in an implementation, stores data associated with users of the user devices 110. The data can include user registration data, device-type data, user designation data, and the like. Further, policy database 144 can store data associated with policies and heuristics-based rules, that can be used by the operations management system 108 to generate on-demand dashboards for the user devices 110.

As shown in the figure, OMS 108 comprises one or more interface(s) 120, a memory 122, and a processing unit 124. In an implementation, the one or more interface(s) are configured to display data generated as a result of the processing unit 124 executing one or more programming instructions stored in the memory 122. The processing unit 124 further comprises data aggregator 126, data analyzer 128, and metrics generator 130. The data aggregator 126 is configured to ingest data associated with one or more service of the services 104, from a variety of data sources. In an implementation, the ingested data is indicative of operational metrics of the services 104 being monitored. The data, in an example, can include information pertaining to performance metrics, events, logs, alarms, warnings, maintenance data, and the like. In an implementation, the data is heterogenous, in that, the content as well as the format of the data is non-consistent. The data aggregator 126 is configured to ingest such heterogenous data from multiple data sources, such as, network management interface data, data services pipeline data, time-series data, and the like. The data can also include data from existing data logging and information technology (IT) monitoring systems. In an implementation, data from each different data source is collected by the data aggregator 126 using one or more data collection engines. The collected data is processed and can be stored by the data aggregator 126, e.g., in the service database 140.

The data analyzer 128 analyzes the collected data and provides an abstract view of the data, for example, by decoupling the data from its source. In an implementation, the abstract view of the data by decoupling of data can be facilitated by the use of virtual machines and/or containers. The decoupled data can then be normalized by the data analyzer 128 and redirected to specific storage repositories (not shown), created for each type of data. The decoupled and normalized data, in an implementation, is utilized by the data analyzer 128 to generate labels associated with a plurality of performance metrics for inspection of one or more services 104, in real-time or near-real time. In an implementation, the collected data, when infused with these labels, can be cross-correlated to monitor performance metrics of the one or more services 104.

The data analyzer 128 is further configured to use labeled data to generate a plurality of database queries, such that a given database query, when resolved, provides information on one or more performance metrics of a service 104 being monitored. For instance, the data analyzer 128 generates all possible database queries for processed data stored in various repositories. In an implementation, the database queries can be used by metrics generator 130 to present performance data, as requested by user devices 110, on various interfaces of the user devices 110. In an implementation, the performance data is generated based on resolving a portion of the generated queries responsive to commands received from the user device 110. In an example, the commands received from a given user device 110 can be in a natural language text format, and the metrics generator 130 can convert natural language commands into a programming language (e.g., SQL) commands using one or more machine learning models.

The metrics generator 130, in an implementation, is configured to generate the performance data for display in real-time. The performance data can facilitate a user of a given user device 110 (such as an IT administrator), to root-cause an issue with a given service 104 and troubleshoot the issue, without the requirement of an additional monitoring tools or applications on the user device 110. In an implementation, an end-user can simply send plain text messages (e.g., using an instant messaging application) from their user device 110, to request for performance data for a service 104. Based on the received messages, the metrics generator 130 can generate the performance data in real-time, e.g., in the form of dashboards, to provide important insights regarding performance of the service 104.

In one or more implementations, a number of machine learning models can be used by the OMS 108 to decipher free-form or natural language queries received from user devices 110. For instance, a natural language text query received from a user device 110 is analyzed to identify an underlying database query (e.g. SQL query). By resolving the database query, the OMS 108 is able to access data from various database and internal systems and generate specific performance data requested by the user. In one implementation, exhaustive training may be required to train the machine learning models, such that these models can analyze different types of natural language text received from user devices 110. For example, a given machine learning model is pre-trained on vast amounts of labeled text to learn statistical properties, syntax, and semantics of language. During pre-training, the model learns to predict words in a sentence or fill in missing words in a given context. After pre-training, the model can be fine-tuned for specific tasks or domains by exposing it to additional labeled data in a supervised learning operation. This helps the model specialize in particular applications, such as translation, summarization, or question-answering.

In one implementation, machine learning models configured to process natural language text for soliciting performance data can be trained using an alias dataset including individual aliases, wherein each alias is a short-form textual indicator mapping one or more natural language queries with associated user context corresponding to the natural language queries. Correlating natural language queries to alias strings often involves Natural Language Processing (NLP), wherein a given alias maps user intent or user context gleaned from the natural language query. For example, when a natural language query is received from user device 110, the OMS 108 can break down the natural language query into individual words or tokens. The OMS 108 can then identify grammatical parts of speech for each token. The OMS 108, in one implementation, can invoke a Named Entity Recognition (NER) model to identify entities such as names, locations, or dates, comprised within the natural language query. Post identification of entities, a context corresponding to the natural language query is determined, e.g., based on the processed tokens and identified entities. For example, if the natural language query asks, “What are the sales figures for product X?”, the intent might be to retrieve sales data for a specific product. The OMS 108 can identify relevant entities in the query, e.g., tables or columns in the database (such as those corresponding to products, organizations, revenue, locations, etc.). The OMS 108 creates aliases for entities to simplify and standardize the query. In the example above, “sales figures” can be mapped to an alias “revenue” and “product X” can be mapped to an alias “products.” That is, natural language text is swapped with their corresponding aliases which describe the context of the natural language text. Further, based on the identified context using these aliases, structured database queries are constructed, e.g., translating the user's context into SQL (Structured Query Language) or another database query language. In an implementation, each individual alias, as described above, cumulatively forms the alias dataset. Different alias datasets can be created for different entities managed by the OMS 108.

In one implementation, in order to initially create an alias dataset, a diverse corpus of natural language text is paired with corresponding aliases is, e.g., by processing a threshold number of natural language queries received by the OMS 108. For instance, during a training phase, wherein the alias dataset is created for each entity (e.g., organization or location), the machine learning models processing the natural language text can be trained using the alias dataset to enable these models to accurately decipher user context from the natural language text. In one implementation, using the alias dataset as training data can be beneficial in making the models understand and identify various natural language combinations of text that can be used by different users, e.g., to request the OMS 108 for performance data. However, each user (or organizational entity) may use different keywords or search terms to solicit this data, and therefore, the alias dataset needs to be modified by manual labeling for each different end user. This becomes more crucial since each natural language query needs to be accurately annotated with an alias to ensure that precise database queries are generated using the mapping. This annotation process may require domain knowledge to ensure accurate labeling as well as involve human annotators or experts who understand the mapping between natural language and specific database languages, such as SQL.

In an implementation, using techniques described in this disclosure, the OMS 108 is configured to generate accurate alias datasets to train machine learning models, such that manual labelling and annotation of natural language queries to update the alias dataset is not needed. In the description that follows terms like “alias dataset,” “alias data” or simply “alias” are used interchangeably. Further, individual aliases within an alias dataset is referred to as “aliases” or “alias data strings,” unless otherwise specified.

In one or more implementations alias data can be generated by ascertaining user context by continually recording user interactions with the performance data generated by the OMS 108. For instance, the OMS 108 causes a presentation of performance data to be displayed onto a user device, wherein the data presentation comprises one or more data fields representative of performance metrics of any service 104. The user can interact with the presentation of the performance data, e.g., by modifying one or more data fields. For example, if a performance data presentation comprises pre-populated text fields like “title” or “performance summary,” the user can edit these text fields and either replace these fields with their own natural language text or add or delete text from the pre-populated text fields.

The OMS 108 can record these modifications and determine user context associated with the modifications. In one implementation, the user context can be determined based on a comparison of a natural language phrase extracted from the modified data field with a natural language phrase extracted from the originally pre-populated text from the data field. Based on the difference between the natural language phrases, an alias data string is generated. The alias data string is a natural language textual indicator defining, or otherwise describes, the determined user context. As used herein, in the context of natural language processing (NLP), a “natural language phrase” or “natural language text” refers to a sequence of words or tokens that occur together and convey a specific meaning within a given language. In NLP, phrases are often analyzed and processed to extract information, perform tasks such as sentiment analysis, machine translation, named entity recognition, or syntactic parsing, among others. Natural language phrases may vary in length and complexity, and NLP algorithms are designed to understand and manipulate them to facilitate various language-related tasks.

In one implementation, the OMS 108 continuously records user interactions with performance data presentations to create new alias data strings and/or modify (e.g., augment) previously created alias data. Further, using the alias data augmented with determined user context as training data, a given machine learning model is trained. Inferring user context directly from user interaction to augment the alias dataset allows the OMS 108 to automatically update the alias dataset, without needing an end-user or system administrator to recreate a labeled set of alias data. This data is populated by the OMS 108 using end-users' specific domain language, e.g., which the users add to widgets and dashboards displaying the performance data. Further, using keywords and phrases associated with known entities, templates can be created from the augmented alias data, such that these templates can be used to identify new natural language queries even before such queries are encountered by the OMS 108. These and other implementations are described in the discussion that follows.

In an implementation, the OMS 108 may be based on declarative data pipelines such that the system can be programmed to specify desired outcomes of one or more data processing tasks, rather than specifying the exact steps required to achieve those outcomes. That is, the system 108 is programmed in a manner such that users can focus on what they want to accomplish with their data, rather than programming each low-level implementation detail of how to transform and manipulate the data. In an example, the system 108 may be implemented using a domain-specific language (DSL) or a graphical user interface (GUI). This may make it easier for users to understand and use the system 108, and can also make it easier for developers to build and maintain the system 108 for future applications.

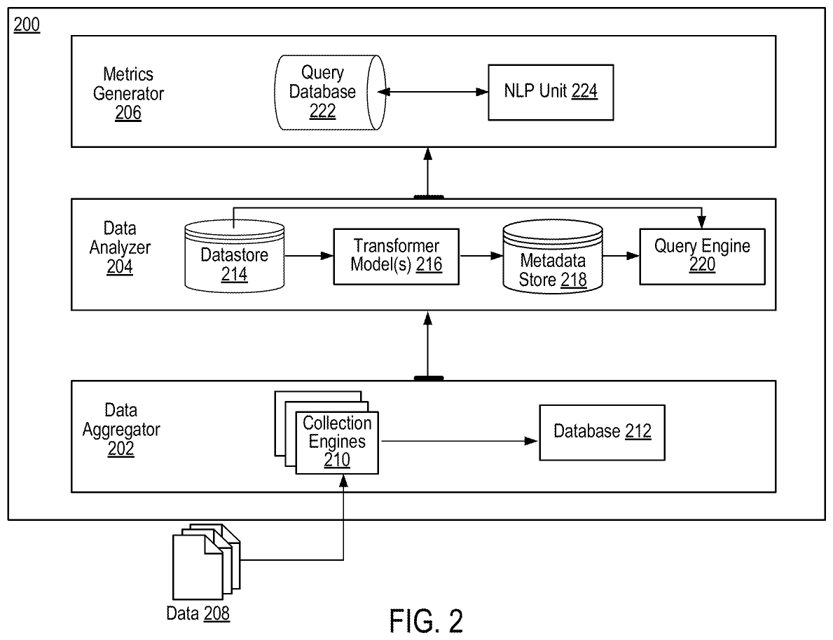

Turning now to FIG. 2, a block diagram of exemplary implementation of various units of an operations management system 200 (or “OMS 200”) is illustrated. For the sake of brevity, FIG. 2 describes the detailed working of a data aggregator 202, a data analyzer 204, and a metrics generator 206, of the OMS 200. Other processing and non- processing units of the OMS 200 are similar to as that described for computing system 108 in FIG. 1.

In an implementation, the OMS 200 can have access to a variety of data sources, such that the data aggregator 202 ingests data 208 from these data sources using a set of custom-built collection engines 210. The collection engines 210, in several implementations, can be configured for ingesting data 208 from one or more data sources (not shown), either by pulling data 208 from the data sources or using push notifications to collect data 208 from the data sources. In an example, the one or more data sources can include IT monitoring and data logging systems. In an implementation, data aggregator comprises pre-integrated collection engines 210 for each different type of data source, such that heterogenous data 208 from varied data sources can be easily collected for analysis. In one implementation, data 208 can also be collected directly from one or more network or cloud services (e.g., services 104 of FIG. 1) being monitored.

In an implementation, the data aggregator 202 can connect to existing inventory or Configuration Management Database (CMDB) tools associated with a service or device being monitored. According to the implementation, the data 208 collected from such tools can include static inventory definitions from a file or dynamic definitions via an Application Programming Interface (API). The data aggregator 202 can also integrate with an existing instance of such a tool (e.g., Netbox instance, etc.) and/or provide inventory as a service using an internal Netbox instance (not shown).

The collected data 208, is used to create a database 212, such that data from the database 212 can be used by one or more components of the OMS 200 for real-time telemetry and enrichment. Further, each collection engine 210, in an implementation, can be cloud-native, such that scaling out of the collection engines 210 for new types of data 208 is possible. The collection engines 210 are configured to provide an entry point for ingestion of data into the OMS 200.

In an implementation, the collected data 208, from the database 212 can be accessed by the data analyzer 204 to create labeled data. The collected data 208, in one example, may lack context and therefore enrichment of the data 208 with context-based labels may be required. To this end, the data analyzer 204 is configured to different sets of data from the database 212, store the sets of data in datastore 214, and process the data using one or more transformer models 216. In an implementation, each different set of data may represent heterogenous data of different types (e.g., collected from different data sources), such as metrics, events, logs, configurations, operational states, and the like. The data analyzer 204 is configured to process the sets of data to normalize the data contained therein and decouple the data from their respective data sources. That is, the data analyzer 204 processes the data to render the data source agnostic so as to facilitate extraction, enrichment, and redirection of said data to appropriate storage repositories (not shown), for each different type of data.

Once the data is normalized and decoupled from its respective source (i.e., processed data), the data analyzer 204 uses one or more models 216 to create labeled data from the processed data. For example, the labeled data is generated using a transformer model 216 and stored in a metadata store 218. In an implementation, the labels are created such that processed data can be correlated to provide insights into the performance of one or more services being monitored. Further, labeled data is fed into a query engine 220 to generate all possible database queries from the data, that would enable the metrics generator 208 to create dashboards for display on a user device GUI (not shown).

In an implementation, the created database queries may be stored in a query database 222. In an example, each database query can be created in a specific programming language, e.g., SQL. The programming language is determined based on factors such as type of service being monitored, source of data from which query has been generated, type of data from which query has been generated, or a combination thereof. In an implementation, the query database 222 is accessible by a natural language processing unit 224 (or NLP unit 224), such that the NLP unit 224 can resolve one or more of these queries responsive to requests received from a user device (e.g., user device 110). According to the implementation, a given user device can send a request to the OMS 200, e.g., for inspecting a given performance metric associated with a given service. The request, in one example, can be received in plain text. In response to receiving such a request, the NLP unit 224 converts the plain text into an appropriate query and correlates the query to one or more database queries stored in the query database 222. Based on the correlation, the metrics generator 208 resolves the database queries found in the query database 222 to create dashboards for inspection of the given performance metric. These dashboards are presented to the user device over a GUI.

As described in the foregoing, in order to process natural language queries (e.g., free-form text queries) received from a user device, the OMS 200 is configured to use an alias dataset (e.g., stored in datastore 214). In an implementation, each time a natural language query is received from a user device, the data analyzer 204 compares the natural language (NL) query with alias strings within the alias dataset, to determine an alias data string corresponding to the natural language query. To do so, the data analyzer 204 first generates respective embedded vectors, each representing a specific alias data string. The data analyzer 204 then compares a generated vector representation of the received NL query with each of the set of embedded vectors generated for the alias dataset. When a given embedded vector from the alias dataset matches the vector representation of the received query, the corresponding alias data string is mapped to the natural language query.

In one implementation, the alias dataset is initially created with individual alias data strings mapped to various NL queries, e.g., by continually updating the alias dataset with new NL queries received from different user devices. These queries are annotated with individual alias data strings, e.g., based on information gathered from existing datasets or created by collecting queries from various sources. In an implementation, the annotation process requires domain knowledge to ensure accurate pairing of NL queries with alias data strings. The annotation process, in some implementations, involves annotation by human annotators or experts who understand how human context or intent is extracted from NL text. In an implementation, the OMS 200 can provide an end-user an option to create their own alias data such that the user-created data is used to annotate natural language queries with corresponding alias data strings. The annotated queries can be stored in query database 222.

However, in this implementation, each time a new organization or customer is onboarded to the OMS 200, the alias data needs to be recreated or modified, so as to ensure that accurate determination of user context from NL text can be programmed for each new user is possible. This is necessary because each user may have their own domain-specific terminologies that they may use to query the OMS 200 for various data. Further, different users may formulate natural language queries differently (e.g., using different language styles or formats). In one example, recreation or updating of alias data can be required when a personnel previously accessing the OMS 200 is replaced with a different personnel, thereby requiring the alias data to be replenished with new phrases and keywords. This, in turn, may require for a system engineer or the customer themselves to create a manually-annotated set of data to update the aliases (or create new aliases) stored within the alias dataset. Since each customer generally has their own specific terminology, which can be domain specific, this task becomes inefficient and tedious, especially when multiple sites, locations, services, devices, etc. are onboarded to the OMS 200 at any given time.

In order to mitigate these issues, in one or more implementations, the OMS 200 is configured to augment (i.e., update) alias data using recorded interaction of users with data presented by the OMS 200 at respective user devices of these users. In one non-limiting implementation, the users can interact with performance data generated by the OMS 200, e.g., by modifying text from one or more data fields in the generated performance data. For example, a user can change text fields included in a dashboard and/or widget presented by the OMS 200. The text fields can originally include NL text corresponding to titles, summary, or other descriptions associated with the performance data. The user can interact with these text fields by modifying or replacing originally included NL text with new NL phrase(s). The data analyzer 204 can determine user context associated with the newly added NL phrase(s), for example, by performing a comparison of a given NL phrase extracted from the modified data field with a NL phrase originally included in the data field. Based on the determined user context, the data analyzer 204 can update the alias dataset.

For instance, using the determined user context, an alias data string previously stored for a given NL phrase is either updated or recreated or if no alias data string corresponding to the NL phrase is available, the alias data string is created and stored in the alias dataset. In an implementation, each user interaction is recorded and analyzed by the data analyzer 204 as discussed above, and based on the user interaction, the originally created alias dataset is continually upgraded. Further, this alias dataset is used as training data to train one or more machine learning models that are programmed to analyze NL queries from user devices, to provide different information (e.g., performance metrics, network faults, device failure, etc.) corresponding to networks or services under surveillance. Furthermore, since the alias dataset is continually improved, the models trained using the alias dataset are also rendered increasingly efficient and accurate in resolving NL queries from the user devices.

In one implementation, an end-user of the user device can modify data fields in presented data by using textual descriptions, color coded identifiers, titles, notes, shorthand, and the like. These modifications can also be analyzed to identify areas of interest for the end-user, e.g., based on user context determined based on the modifications. The user context, in one example, is determined using transformer model(s) 216.

In one implementation, responsive to modifications in the presented data, the updated (or newly generated) alias data strings are also mapped with database queries used to create the originally presented data. This way, the system is enabled to process new NL queries from the user to more accurately predict the requested data to be presented to the user in the future. The quality of presented data gradually improves as the system continually upgrades the mapping between user context (as indicated by alias data strings) and database queries.

In another implementation, the data analyzer 204 can extrapolate NL phrases extracted from recorded user interactions to generate alias data strings not originally present in the alias dataset. For instance, if a given NL phrase added by the user includes keywords associated with a certain device or service, the data analyzer 204 can recognize other keywords similar to the NL phrase, and generate additional alias data strings corresponding to the other keywords. In an example, NL phrases recorded as user input are analyzed in light of previously created alias data strings, to identify user context associated with a given keyword. The user context can then be extrapolated to automatically create additional alias data strings for similar keywords, e.g., even before they are encountered by the OMS 200. As used herein, “similar keywords” or “similar phrases” are keywords or phrases used for soliciting the same information for different devices, entities, services, and the like. For example, stock tickers “GOOGL” and “APPL” are considered as similar keywords, as both keywords are used to request information on current stock prices, albeit of different stocks (stocks for Google® and Apple®, respectively). In one implementation, similar keywords for a given user can be extracted using a Named Entity Recognition (NER) model from one or more datastores (not shown). Other implementations are contemplated.

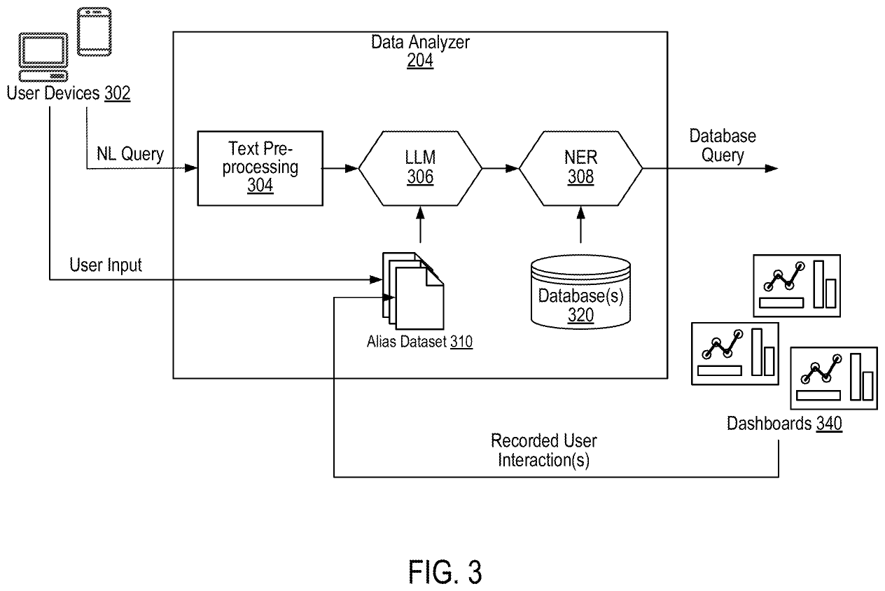

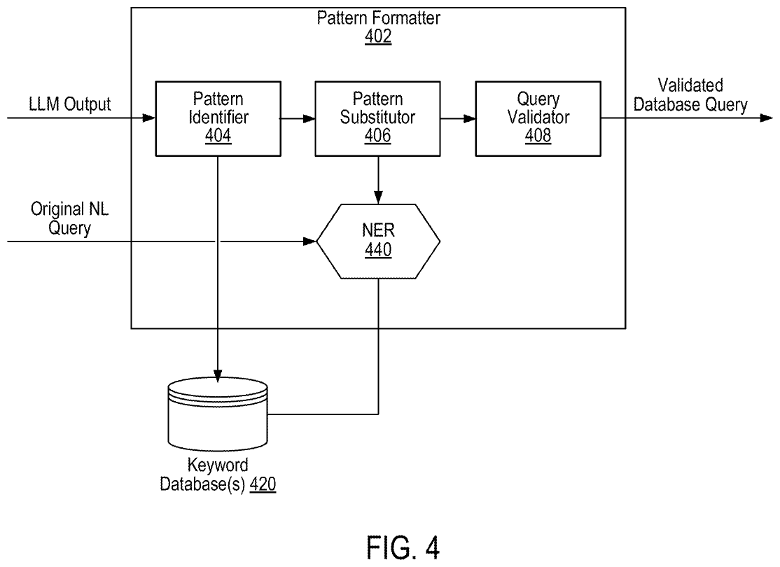

In an implementation, the additional alias data strings are added to the originally created alias dataset. Further, the machine learning models trained using the alias dataset are retrained using the updated alias dataset. Creation of alias data strings and extrapolation of previously created alias data strings to generate new alias data strings is further explained with respect to FIGS. 3 and 4, respectively.

Referring now to FIG. 3, a block diagram illustrating creation of alias dataset by recording user inputs is described. It is noted that one or more operations depicted in the figure are performed by one or more units of an operations management system (OMS) 200 described in FIG. 2. These units are called out in the description of FIG. 3, wherever appropriate.

As shown in the figure, natural language queries are received by the data analyzer 204, e.g., as requests generating from user devices 302. In one example, the requests from the user devices 302 may be created by system engineers, customers, administrators, or other personnel to solicit performance data associated with devices or services under surveillance (e.g., services 104 described in FIG. 1). In the implementation discussed herein, the natural language queries include text queries, however, these queries can also include other form of natural language queries such as audio queries that can undergo a speech-to-text operation. The data analyzer 204 performs a text pre-processing operation 304 for processing the natural language queries. In an example, the text pre- processing operation 304 can include, without limitation, lowercasing, text tokenization, removal of punctuations and stop words, stemming, processing special characters, and the like. The text pre-processing operation 304, in an implementation, is performed to clean and transform raw text data into a format that is suitable for analysis or modeling.

In one implementation, the processed NL text is then fed into a large language model (LLM) 306. In an example, the LLM 306 undergoes a supervised training to enable the LLM 306 to generate database queries (e.g., SQL queries) from the processed NL text. In one implementation, the LLM 306 is originally trained using an alias dataset 310, as shown. According to the implementation, the alias dataset 310 includes a corpus of data, e.g., created and hand-labeled manually, including NL text annotated with alias data strings, such that the annotated NL text can be further processed to generate database queries.

In one implementation, during a training phase, the LLM 306 can be trained using previously created alias dataset 310 for a threshold number of NL queries initially received by the OMS 200. The threshold number of NL queries can be application specific. For instance, the predetermined threshold number (or instances) of NL queries can be selected based on different devices or services under surveillance, different clients, different sites or locations, and the like. Once initial training for the LLM 306 is complete, the data analyzer 204 can utilize the trained LLM 306 for processing new NL queries received from one or more user devices 302.

During the training phase, each time a new NL query is received and the text pre-processing operation 304 is performed, the processed text is fed to the trained LLM 306 to analyze the NL text query. For instance, “Seq2Seq” models, which are designed to handle input and output sequences of varying lengths, can be commonly used to train the LLM 306. A given number of NL queries and database queries are tokenized, and input representations are created for both. The NL queries are typically tokenized into words or sub-words, while the database queries may be tokenized into appropriate keywords and identifiers. The LLM 306 is trained on the initial alias dataset 310, wherein the LLM 306 uses the textual identifiers corresponding to each NL query (stored as alias data strings in the alias dataset 310) to learn to predict associated database queries. During training, the LLM 306 parameters are adjusted to minimize the difference between the predicted database queries and the ground truth database queries in the training dataset.

In one implementation, the trained LLM 306 is used to generate database queries for new natural language queries. During inference, the natural language query (i.e., after text pre-processing operation 304) is input to the LLM 306, and the model produces a predicted database query. Further, post-processing steps can be applied to the generated database query to ensure its syntactic and semantic correctness. This involves fixing grammar, ensuring that keywords are used appropriately, and validating the overall structure of the database query.

In another implementation, the database query generated by the trained LLM 306 further undergoes processing by a pretrained Named Entity Recognition (NER) model 308, in order to further improve the database query based on different keywords used by different client entities (e.g., different customers or organizations onboarded to the OMS 200). The NER model 308, in one example, can be trained using a corpus of data (domain-specific keywords, text identifiers, and/or other phrases) specific to different entities, and stored in one or more databases 320. In one implementation, the databases 320 store annotated data specific to various entities, such that the data for any given entity is used to train the NER model 308 to generate entity-specific database queries associated. In one example, each entity (e.g., customer) can have different domain or entity-specific terminologies or keywords for the same parameter, e.g., “installation site” may be simply referred to as “site” by a given entity and “location” by some other entities. Similarly, one or more entities can have respective shorthand identifiers for each device, e.g., a first entity can refer a given device using identifier “DEV,” while another entity can refer the same type of device using an alpha-numeric identifier such as “Dn,” wherein n could be a positive integer. Since multiple entities can have different ways of addressing similar devices or services, using the NER model 308 database queries generated by the LLM 306 can be correlated with specific entity keywords, to accurately reflect information requested from the user devices 302 with respect to a given entity. The final database query, i.e., created using LLM 306 and processed using NER model 308, is outputted as shown.

In one or more implementations, when new entities (e.g., customers, sites, devices, etc.) are onboarded to the OMS 200, the alias dataset 310 needs to be recreated or updated, so as to ensure that domain-specific keywords associated with that particular entity are added to the alias dataset 310. This essentially results in recreation or updating of training data to train LLM 306. Conventionally, for updating the alias dataset 310, either a customer or a system engineer needs to create a manually-labeled set of data (i.e., inclusive of newly learnt keywords corresponding to the new entity) to update the alias data strings (or create new alias data strings) stored within the alias dataset 310. Since each entity has specific associated terminology, which can be domain specific, this task becomes inefficient and tedious, especially since multiple entities such as sites, locations, services, devices, etc. are monitored using the OMS 200 at any given time. Further, the updates to the alias dataset 310 need to be performed each time a new entity is managed by the OMS 200.

In one implementation, in order to for adding manually-labeled set of data for the new entity to update the alias dataset 310, the OMS 200 can present an option to user devices 302 to create the manually-labeled set of data using an application inherent on the user devices 302. This data is then received by the OMS 200 (as shown using “user input”). Based on data received from different user devices 302, the OMS 200 updates the alias dataset 310. In one example, the alias dataset 310 is updated by replacing originally created alias data strings with manually-labeled data received from the user devices 302. In another example, the alias dataset 310 can be updated by augmenting the originally created alias data strings with manually-labeled data received from the user devices 302. Further, each time such update to the alias dataset 310 is performed, the data analyzer 204 is configured to retrain the LLM 306 with the updated alias dataset 310 as training data.

In an implementation, enabling end-users to update the alias dataset 310 can result in corruption of data, especially due to human errors, incorrect annotations, ambiguity in guidelines, lack of standardization, or other similar issues. Further, the OMS 200 also needs to employ additional computing resources each time new user input is received, in order to ensure that incorrect and corrupted data is not stored in the alias dataset 310.

In one or more implementations, to mitigate issues arising due to manual updating of the alias dataset 310, the OMS 200 is configured to automatically update, recreate, or augment the alias dataset 310, without the need of human intervention. In one implementation, this is done by autonomously updating the alias dataset 310 based on determined user context. In an implementation, user interaction with one or more sets of presented data (e.g., dashboards 340) can be recorded. The recorded user interactions are analyzed by the data analyzer 204 and a user context is determined based on the analysis. In an implementation, the user interaction can include a user input that modifies one or more data fields of the presented data. For example, the user can change a “title” data field and modify or replace the original text presented in the field with other natural language text. In another example, the user can highlight sections of the presented data that are of particular interest to them. In yet another example, the OMS 200 can autonomously identify particular data presented to the user that the user interacts with most (e.g., based on how frequently the data is requested by the end-user, and/or how much time the end-user spends interacting with the data).

As shown in the figure, metadata from dashboards 340 is extracted from the dashboards 340. This metadata can be stored in a data store (not shown). In one implementation, the extracted metadata is utilized by the data analyzer 204 to determine a user context of an end-user interacting with the dashboards 340. According to the implementation, the user context is determined based on comparison of original text and user modified text in one or more data fields of a given dashboard 340. For instance, a user can change the system generated title of a dashboard 340. In another example, the user can add their own specific NL text into one or more data fields of the dashboard 340, that did not contain any textual matter originally. In another example, the user can add one or more data fields to the dashboards 340 and add textual descriptors to these fields. In one implementation, based on the newly added, modified, or replaced NL text in the data fields, the data analyzer 204 identifies various entities mentioned in the text, including but not limiting to, names, organizations, locations, dates, etc. The user's input can then be classified into predefined categories or intents, such as asking a question, making a request, expressing an opinion, etc. The data analyzer 204 can further perform a sentiment analysis to identify the sentiment expressed in the text. Further, the user's input is analyzed with respect to previous interactions of the user with one or more dashboards 340. Based on the sentiment analysis and previous interactions, the user context of the user is determined.

In an implementation, since multiple different customers can use the OMS 200 at any given time, user context for each individual user can be different for the same dashboard 340. For instance, a first user can solicit a dashboard 340 using NL text focused on maintenance operations, whereas another user can request the same dashboard 340 using NL text focused on reporting. Based on the context determined specifically for a given user, the data analyzer 204 can identify areas of interest for the user. Based on the user interest, along with NL text extracted from the different fields of the dashboards 340, the data analyzer 204 continually identifies user context. The determined user context is then used to generate alias data strings, specific for the end-user, such that these alias data strings are added to the originally produced alias dataset 310 (or a completely new alias dataset is created).

In one implementation, the new alias data strings are generated in natural language, autonomously by the OMS 200 without user intervention. The alias data string can identify a user context, with respect to different natural language text such as keywords and phrases. In one implementation, the alias data strings include a mapping between user context and one or more keywords or phrases in natural language. For instance, for a given user, an alias data string can include a keyword, such as “act_dev” and a textual descriptor describing the keyword in light of the user's context. In this example, the textual descriptor can include “active network devices.” When a machine learning model is trained using the alias data strings created as described above, the machine learning model can efficiently predict the user context from simple NL text. In another example, the alias data strings can also be created as shortform natural language sentences defining the user context.

The newly created or updated alias data strings are each stored in the alias dataset 310. Further, each machine learning model (e.g., LLM 306) using the alias dataset 310 as training data, is retrained with the updated alias dataset 310. In an implementation, the alias dataset 310 further stores a correlation of individual alias data strings with database queries. That is, when a given machine learning model is trained using the alias dataset 310, and encounters a NL query from a user device 302, the model is able to identify one or more database queries. This is done by retrieving an alias data string corresponding to the NL query and identifying a database query correlated with the alias data string.

In operation, each alias data string is converted to an embedded vector representation (e.g., using one or more transformer models 216), such that each vector representation is indicative of a semantic meaning of a given alias data string (i.e., based on user context). In one implementation, the vector representations are stored in a vector database (not shown). Each time a new NL query is received from a user device 302, the query is also converted to a vector representation, which is compared to all the vector representations of stored alias data strings. This allows identifying a given alias data string based on the natural language query, and enabling the machine learning model to accurately identify a corresponding database query.

In one implementation, the data analyzer 204 continues monitoring user interaction with the newly and previously created dashboards 340, and records user input associated with the dashboards 340. Based on analyzing the recorded user inputs, user context is ascertained, and new alias data strings are generated. Further, the data analyzer 204 maps these alias data strings with the natural language text that were received from the user devices 302 originally. This mapping (e.g., stored as alias dataset 310) is then used to continually train models (e.g., LLM 306). Therefore, a continuous creation and improvement of a correlation between natural language queries with alias dataset 310 mapped to database queries is realized, without the need of user intervention. Further, retraining of machine learning models improves the accuracy of these models to predict user context from new NL queries received from the user devices 302, as they are encountered by the OMS 200. That is, using user context derived from natural language text inputted by the user, as basis to train models, allows the OMS 200 to generate accurate training data, without needing an end-user or system administrator to manually create and update a labeled set of data.

In one implementation, recreated or updated alias data strings are further extrapolated to identify a template for creating additional alias data strings (e.g., based on similar keywords or phrases), such that these can be added to the alias dataset 310. The creation of additional data strings enables the OMS 200 to organically update and improve the alias dataset 310, such that new language queries can be efficiently handled by the system. The generation of additional alias data strings is further described with respect to FIG. 4.

Turning now to FIG. 4, a block diagram illustrating creation of additional aliases by extrapolating previously created aliases is described. As shown in the figure, an initial large language model (LLM) output, e.g., a database query, is processed by a pattern formatter 402. In one implementation, the pattern formatter 402 is integral to a data analyzer (e.g., data analyzer 204) of the operations management system. In another implementation, the pattern formatter 402 is a standalone computing unit. The pattern formatter 402 firstly identifies whether an LLM output (e.g., database query) includes one or more discernable patterns. In one example, the identification of the patterns is performed using a pattern identifier 404. The pattern identifier 404 can determine patterns in the LLM output based on similar keywords recorded from user interactions with presented data (e.g., widgets and/or dashboards). For instance, keywords extracted from the user interactions are compared with entity-specific keywords stored in a keyword database 420. In an implementation, the keywords from user input is processed to determine user context. The determined user context is used to identify other entity-specific keywords from the keyword database 420 having similar context or meaning associated with them. In one implementation, the keyword database 420 includes, for multiple entities or customers, query-able keywords corresponding to each entity or customer. For example, for any given entity, the keyword database 420 can include shortform identifiers for different devices, services, personnel, locations, and the like. Further, patterns can be recognized based on extrapolation of previously created alias data strings stored in the alias data set.

In one non-limiting example, the LLM output is a database query in the following format:
#show actv_dev for IND
   The pattern identifier 404 can process the above database query and identify that the above database query is used to generate a dashboard showing “active devices” installed in the “India” location. In one example, this identification can be performed by analyzing user context with respect to data presented in response to resolving the above database query. Further, based on an alias data string corresponding to the above database query, the pattern identifier 404 determines that the keyword “IND” in the query, as a potential keyword in an existing pattern of keywords. The pattern of keywords is then analyzed by a pattern substitutor 406.

In one implementation, the pattern substitutor 406 invokes a Named Entity Recognition (NER) model 440 to identify similar keywords in the pattern. Referring to the above example, using the keyword “IND” corresponding to the above database query, the pattern substitutor 406 determines additional three-letter identifiers (e.g., “USA,” “CAN,” “FRA,” “BEL”), and ascertains that these additional keywords also correspond to country names (i.e., similar to “IND” referring to India). In one implementation, this assertion is further verified by the pattern substitutor 406 by using the NER model 440 to cross-reference an original natural language query (as shown) that was inputted into the OMS, in response to which the above database query was generated initially. In this example, the original natural language query received could be “Active devices in IND.” The NER model 440 analyzes the original natural language query, along with keywords and phrases corresponding to the user (e.g., extracted from the keyword database 420) to determine all other keywords having similar meaning or context as the keyword present in the database query generated as the LLM output.

In an implementation, the pattern substitutor 406 substitutes the pattern (wherein the original pattern identifies the three-letter identifier as country name) with a placeholder. For instance, the pattern substitutor 406 substitutes each three-letter identifier of a country with a placeholder “COU” representing the keyword “Country.” Further, corresponding alias data strings for all additional keywords in the pattern can be formulated. For instance, if originally created alias data string for natural language query “Active devices in IND” is “Act_dev|COU=India,” new alias data strings for other locations of interest, e.g., “Act_dev|COU=United States of America” or “Act_dev|COU=Canada” can be created and added to the alias data set. This way, natural language queries soliciting information on these parameters can be added as valid natural language queries, even before these queries are actually encountered by the system. In one implementation, the new alias data strings are mapped with the original alias data string, and this mapping is correlated with the corresponding entity. The mapped alias data strings correlated with the entity are stored in the alias dataset, as-such. Further, the machine learning model used to process the natural language queries to predict database queries can also be trained (or retrained) using the updated alias data (i.e., original alias data strings correlated with additional alias data strings) as training data. In doing so, the OMS enables the model(s) to be continually trained using additional alias data, such that newly received natural language queries can be processed to generate more accurate database queries.

In one implementation, based on the mapped alias data strings stored in the alias dataset, the OMS can automatically ascertain the context of entity-specific natural language queries. For example, each time a three-letter identifier is encountered in a natural language query, e.g., “Active devices in BEL,” the OMS can seamlessly generate a database query to generate data for “active devices in Belgium”, by simply querying the alias dataset. This is possible due to alias dataset storing mappings between different alias data strings for different entities, enabling efficient and accurate analysis of the natural language query in light of these strings. It is noted that even though a single example has been described herein, multiple such implementations of generating new alias data strings using similar keywords and phrases are possible. Such implementations are contemplated.

In an implementation, based on newly created alias data string(s), the originally generated database query, is also updated using the placeholder and validated for correctness. As shown, the query validator 408 receives the placeholder from the pattern substitutor 406, and generates a validated database query. In one implementation, the validated database query is created in a manner that the database query can be resolved to generate data based on each newly created alias data string.

In one non-limiting example, a previously received natural language query “Get me GOOGL,” can be analyzed to mean that a user device is soliciting a stock price of the Google® stock, wherein “GOOGL” represents the ticker of the stock. Based on the process described above, the pattern substitutor 406 can substitute GOOGL with the placeholder “TICKER,” such that other natural language queries with similar keywords can be automatically identified as tickers. In some non-limiting examples, “APPL” can be recognized as a ticker for the Apple® stock, “MSFT” can be recognized as a ticket for the Microsoft® stock, and the like. These tickers can be converted to alias data strings (e.g., in the same format as the alias data string corresponding to the Google® stock), and added to the alias data set, even before these are encountered by the OMS. Further, the database query initially generated corresponding to the original natural language query soliciting information about the Google® stock, can be updated and validated to also respond to natural language queries using any such ticker. That is, the language models are able to predict additional natural language queries that can be encountered by the system, based on user context established by analyzing previously processed natural language text. It is noted that the above description is merely an example of creation of new alias data strings based on similar keywords, and other implementations (e.g., based on entity-specific domain keywords) are possible and are contemplated.

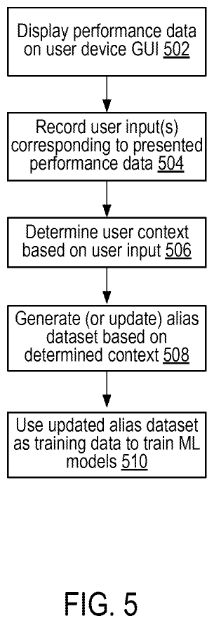

FIG. 5 illustrates a method for generating training data for one or more machine learning models based on determined user context. As described in the foregoing, natural language text (e.g., free-form text queries) can be analyzed to determine user context. This user context can be utilized to generate an alias dataset wherein the alias dataset includes textual indicators mapping various natural language queries with user context for various different users. Further, machine learning models can be trained using the alias dataset as training data, such that the models can effectively and accurately predict requested output data by a given user (e.g., in response to a query received by an operations management system).

In one implementation, the OMS is configured to generate performance data corresponding to a performance metric of a given network device or service under surveillance. According to the implementation, the generated performance data is displayed on a graphical user interface of a user device that has requested the performance data from the OMS (block 502). In an implementation, the presented performance data includes one or more data fields each including information on a given performance metric associated with the network or service.

Once the data is presented to the user device, the user may interact with the data. For example, the user can change values (or text) in data fields. In another example, the user can interact with the data by highlighting text for certain devices or performance metrics. In an implementation, the OMS is configured to record one or more user inputs corresponding to the presented performance data (block 504). For example, the system can record a user input such as when a user adds, replaces, or otherwise modifies a “title” data field in a dashboard displayed onto the user device. In another example, the user can add summaries or short text descriptions to various widgets presented as performance data. In one implementation, the user inputs can also include other user interactions, such as, a total time user has interacted with a particular type of data, a number of times a given type of data is requested by a user device, any particular performance data marked as favorite by the user, and the like. Other implementations are possible and are contemplated. In an implementation, the OMS is configured to determine, based on the recorded user input, user context for different users (block 506).

In one implementation, the OMS can determine user context associated with the user input. In an implementation, the user context is determined based on a comparison of a natural language text extracted from a modified data field with a natural language phrase originally presented within that data field. For example, values in a data field corresponding to pseudonyms of various network devices can be altered by the user. In another example, a system provided widget title is modified by the user. These modifications are recorded and modified data in a given data field is compared with originally presented data for that data field. For example, the OMS can extract natural language keywords or phrases from a user entered widget title and compare this with natural language keywords or phrases in the originally provided widget title. Based on this comparison, the OMS can ascertain a context of the user with respect to particular performance data reported by means of the widget.

Using the determined context for various users, the OMS updates an originally created alias dataset (block 508), e.g., by updating individual alias data strings and/or creating new alias data strings. In one example, the OMS generates alias data strings corresponding to determined context for each user interaction recorded by the system. In one implementation, the updated alias dataset includes various alias data strings corresponding to different entities (e.g., networks, equipment, customers, etc. managed by the OMS). Further, each data string is indicative of a particular user context determined for the user by analyzing user interaction with various data presented to the user's device. In an example, each alias data string is generated such that it represents a shortform natural language descriptor that maps a natural language query received from a user device with its context determined based on user interactions with performance data. It is noted that multiple natural language queries can be mapped to a single determined context (e.g., since users can formulate natural language queries differently to solicit the same information), and therefore all such queries can be correlated with a single alias data string.

The alias dataset is used as training data to train one or more machine learning models (block 510). In one or more implementations, these models can be programmed to analyze NL queries received from various user devices, to provide different information (e.g., performance metrics, network faults, device failure, etc.) corresponding to networks or services under surveillance. Furthermore, each time new alias data strings are generated and the alias dataset is updated, the models are retrained using the updated alias dataset. This enable continuous improvement in efficiency and accuracy of the models in resolving user queries.

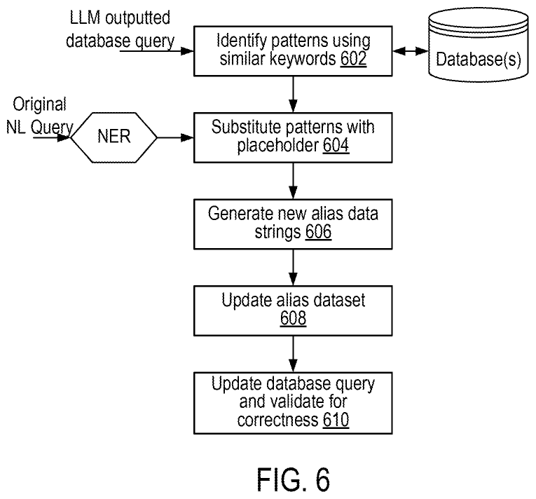

FIG. 6 illustrates a method for updating alias data by extrapolating existing natural language text. As described in the foregoing, a machine learning model can predict a database query, based on NL queries received from a user device. An operational management system (OMS), in one implementation, is configured to process the predicted database query to identify patterns inherent within the database query (block 602). In one example, patterns can be determined based on comparison of entity-specific keywords and/or phrases stored in a keyword database with keywords identified from user interaction with performance data. In an implementation, the keywords identified from recorded user interactions are processed to determine user context (as described with respect to FIG. 3). The determined user context is utilized to identify entity-specific keywords and/or phrases from the keyword database having similar intent or meaning (as described in FIG. 4). In one implementation, the keyword database includes, for multiple entities, query-able keywords corresponding to each user (e.g., entity or customer). For example, for any given user, the keyword database can include shortform identifiers for different devices, services, personnel, locations, and the like.

The keywords within the identified patterns are then substituted with placeholders (block 604). In one implementation, a Named Entity Recognition (NER) model is invoked to identify other keywords in the pattern for substitution with the placeholder. For example, using the keyword(s) identified in the database query, other keywords are identified for the user corresponding to the database query. These keywords are verified by using the NER model, e.g., by cross-referencing a NL query (as shown) that was inputted into the OMS, in response to which the database query was originally generated. The NER model further analyzes the NL query, along with keywords and phrases corresponding to the entity (e.g., extracted from the shown database(s)), to determine all keywords having similar semantic meaning or intent as the keyword present in the database query generated as the LLM output.

Based on substituting keywords identified in a pattern with the placeholder, new NL queries are generated and validated (block 606). In one implementation, new alias data strings are also generated based on the NL queries. Further, the OMS can update the alias dataset with the newly added alias strings (block 608) That is, the OMS is able to predict NL queries that can be encountered by the system, based on user context as well as on formulation of previously received NL queries. Further, the OMS can also update the initial database query outputted by the OMS (block 610), in a manner that the database query can correspond to each newly created alias data string, while maintaining the associations with existing alias data strings. In an implementation, the model that initially generated the database query is retrained each time additional alias data strings are created by extrapolating previously generated alias data strings. This way, the model is trained to generate accurate database queries, even for natural language queries that have not been yet encountered by the OMS.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
a processor configured to:
receive user input that modifies at least one data field of one or more data fields of a user interface;
determine a context associated with the user input, based at least in part on a comparison of a natural language phrase extracted from the modified data field with a natural language phrase extracted from the at least one data field;
generate a first set of natural language text defining the determined user context; and
train a machine learning model using the first set of natural language text.

2. The system as claimed in claim 1, wherein, responsive to a query received from the user device, the processor is configured to:
generate a set of embedded vectors, wherein each embedded vector represents a specific natural language phrase comprised within the first set of natural language text;
compare a vector representation of the received query with each of the set of embedded vectors; and
responsive to a given embedded vector from the set of embedded vectors matching the vector representation of the received query, map a natural language phrase corresponding to the given embedded vector with the received query.

3. The system as claimed in claim 2, wherein the processor is configured to cause the trained machine learning model to generate a database query corresponding to the received query, based at least in part on the natural language phrase mapped with the received query.

4. The system as claimed in claim 3, wherein the processor is configured to generate a second data presentation based at least in part on processing the database query.

5. The system as claimed in claim 1, wherein the processor is configured to:
extrapolate the first set of natural language text, based at least in part on entity- specific keywords corresponding to the user device, to populate a second set of natural language text; and
retrain the machine learning model using the second set of natural language text correlated with the first set of natural language text.

6. The system as claimed in claim 5, wherein the processor is configured to extract the entity-specific keywords from one or more datastores using a Named Entity Recognition (NER) model.

7. The system as claimed in claim 1, wherein the machine learning model is a large language model (LLM).

8. A method comprising:
causing, by an operations management system, a first data presentation to be displayed on a graphical user interface of a user device, the first data presentation at least in part comprising one or more data fields each representative of a performance metric of a given network device;
recording, by the operations management system, a user input that modifies at least one data field from the one or more data fields;
determining, by the operations management system, user context associated with the user input, based at least in part on a comparison of a natural language phrase extracted from the modified data field with a natural language phrase extracted from the at least one data field;
generating, by the operations management system, a first set of natural language text defining the determined user context; and
training, by the operations management system, a given machine learning model using the first set of natural language text.

9. The method as claimed in claim 1, the method further comprising:
responsive to a query received from the user device:
generating, by the operations management system, a set of embedded vectors, wherein each embedded vector represents a specific natural language phrase comprised within the first set of natural language text;
comparing, by the operations management system, a vector representation of the received query with each of the set of embedded vectors; and
responsive to a given embedded vector from the set of embedded vectors matching the vector representation of the received query, mapping, by the operations management system, a natural language phrase corresponding to the given embedded vector with the received query.

10. The method as claimed in claim 9, further comprising causing, by the operations management system, the trained machine learning model to generate a database query corresponding to the received query, based at least in part on the natural language phrase mapped with the received query.

11. The method as claimed in claim 10, further comprising generating, by the operations management system, a second data presentation based at least in part on processing the database query.

12. The method as claimed in claim 8, further comprising:
extrapolating, by the operations management system, the first set of natural language text, based at least in part on entity-specific keywords corresponding to the user device, to populate a second set of natural language text; and
retraining, by the operations management system, the given machine learning model using the second set of natural language text correlated with the first set of natural language text.

13. The method as claimed in claim 12, further comprising extracting, by the operations management system, the entity-specific keywords from one or more datastores using a Named Entity Recognition (NER) model.

14. The method as claimed in claim 8, wherein the given machine learning model is a large language model (LLM).

15. A system comprising:
a metrics generator configured to:
cause a first data presentation to be displayed on a graphical user interface of a user device, the first data presentation at least in part comprising one or more data fields each representative of a performance metric of a given network device; and
a data analyzer configured to:
record a user input that modifies at least one data field from the one or more data fields;
determine user context associated with the user input, based at least in part on a comparison of a natural language phrase extracted from the modified data field with a natural language phrase extracted from the at least one data field;
generate a first set of natural language text defining the determined user context; and
train a given machine learning model using the first set of natural language text.

16. The system as claimed in claim 15, wherein, responsive to a query received from the user device, the data analyzer is configured to:
generate a set of embedded vectors, wherein each embedded vector represents a specific natural language phrase comprised within the first set of natural language text;
compare a vector representation of the received query with each of the set of embedded vectors; and
responsive to a given embedded vector from the set of embedded vectors matching the vector representation of the received query, map a natural language phrase corresponding to the given embedded vector with the received query.

17. The system as claimed in claim 16, wherein the data analyzer is configured to cause the trained machine learning model to generate a database query corresponding to the received query, based at least in part on the natural language phrase mapped with the received query.

18. The system as claimed in claim 17, wherein the data analyzer is configured to generate a second data presentation based at least in part on processing the database query.

19. The system as claimed in claim 15, wherein the data analyzer is configured to:
extrapolate the first set of natural language text, based at least in part on entity- specific keywords corresponding to the user device, to populate a second set of natural language text; and
retrain the given machine learning model using the second set of natural language text correlated with the first set of natural language text.

20. The system as claimed in claim 19, wherein the data analyzer is configured to extract the entity-specific keywords from one or more datastores using a Named Entity Recognition (NER) model.
